(19) United States
(12) Patent Application Publication
(10) Pub. No.: US 2022/0119290 A1
(43) Pub. Date: Apr. 21, 2022

(54) Microwave Non-Thermal Atmospheric Plasma UV-Assisted PFAS Decomposition & Bio-Contaminant Water Purification System

(71) Applicants: Desmond A. Fraser, Herndon, VA (US); Hossein Ghaffari Nik, Herndon, VA (US); Akrem Aberra, Herndon, VA (US); David Davis, Herndon, VA (US); Shelley Marie Grandy, Herndon, VA (US); Richard Bergeron McMurray, Herndon, VA (US)

(72) Inventors: Desmond A. Fraser, Herndon, VA (US); Hossein Ghaffari Nik, Herndon, VA (US); Akrem Aberra, Herndon, VA (US); David Davis, Herndon, VA (US); Shelley Marie Grandy, Herndon, VA (US); Richard Bergeron McMurray, Herndon, VA (US)

(21) Appl. No.: 17/505,599

(22) Filed: Oct. 19, 2021

Related U.S. Application Data
(60) Provisional application No. 63/093,690, filed on Oct. 19, 2020.

(51) Int. Cl. C02F 1/66; C02F 1/32; C02F 1/58

(52) U.S. Cl. CPC C02F 1/66; C02F 2101/36; C02F 1/58; C02F 1/32

(57) ABSTRACT

Potable water is produced by removing contaminants such as toxic, fluorinated perfluoroalkyl substances (PFAS).

### RELATED APPLICATION

This application claims the benefit of priority to U.S. Provisional Application No. 63/093,690 (“'690 application”) filed Oct. 19, 2020 and incorporates by reference the entire disclosure of the '690 application.

### INTRODUCTION

It is desirable to eliminate toxic, fluorinated PFAS (perfluoroalkyl substances), aka “forever chemicals”, from potable water sources.

Accordingly, the Applicants disclose methods and systems directed to the reduction and/or elimination of such forever chemicals to produce potable water.

### SUMMARY

In one embodiment, an method for providing potable water may comprise: monitoring and analyzing a pH of water in a treatment loop; adjusting the pH of the water by adding fresh water to establish a near-neutral pH level necessary for decontamination of toxic, fluorinated perfluoroalkyl substances (PFAS) to occur; and decontaminating the water to remove the PFAS.

Such a method may further comprise mixing and atomizing the water to break down and eliminate the PFAS and other contaminants, where, for example, the flow rate of the water may be approximately 5-10 LPM.

In addition, such a method may further comprise denaturing the water to remove biological contaminants by, for example, applying 220 nanometer (nm) to 260 nm ultraviolet C (UV-C) light to the water.

To remove contaminants the method may more particularly comprise the UV-A decomposition of contaminants and the UV-C disinfection of bio-contaminants in the water.

In an embodiment, the method may comprise: (i) simultaneously treating PFAS and bio-contaminants by decomposition and disinfection; and sequentially treating the bio-contaminants by disinfection; or (ii) simultaneously treating PFAS and bio-contaminants by decomposition and disinfection; simultaneously treating PFAS and bio-contaminants by decomposition, and sequentially treating bio-contaminants by disinfection.

### BRIEF DESCRIPTION OF THE DRAWINGS

FIG. 1 depicts an exemplary system for removing contaminants and producing potable water according to one embodiment.

FIG. 2 depicts an exemplary configuration of components of a system for removing contaminants and producing potable water according to one embodiment

FIG. 3 depicts an exemplary configuration of components of a system for removing contaminants and producing potable water according to another embodiment

### DETAILED DESCRIPTION, WITH EXAMPLES

Exemplary embodiments of systems and methods for eliminating toxic, fluorinated PFAS (perfluoroalkyl substances), aka “forever chemicals”, from potable water sources are described herein and are shown by way of example in the figures. Throughout the following description and figures, like reference numbers/characters refer to like elements.

It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

It should also be understood that one or more exemplary embodiments may be described as a method. Although a method may be described as sequential, it should be understood that such a method may be performed in parallel, concurrently or simultaneously. In addition, the order of each step within a method may be re-arranged. A method may be terminated when completed, and may also include additional steps not included in a description of the method.

As used herein, the term “and/or” includes any and all combinations of one or more of the associated listed items. As used herein, the singular forms “a,” “an” and “the” are intended to include the plural form, unless the context and/or common sense indicates otherwise. It should be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The words “embodiment”, “exemplary” or some combination of the two indicate an example of the present invention.

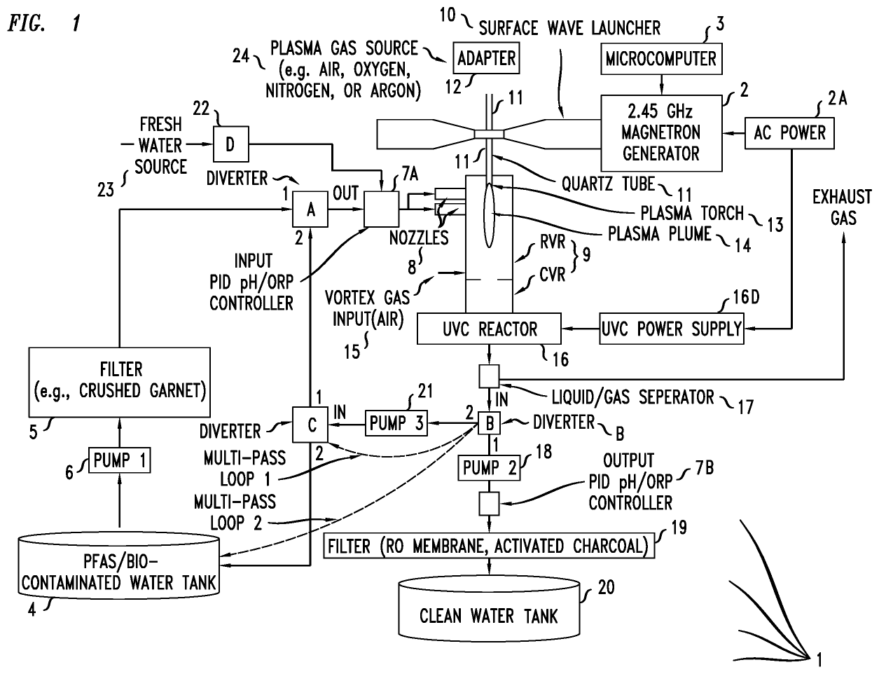

Referring to FIG. 1 there is depicted an exemplary system 1 for removing unwanted chemicals from potable water sources.

To the extent that any of the figures or text included herein depicts or describes dimensional information it should be understood that such information is merely exemplary to aid the reader in understanding the embodiments described herein and may, or may not be the actual scale of a component. Further, other dimensions may be used to construct the inventive devices, systems and components described herein and their equivalents without departing from the scope of the inventions.

Though not described in detail herein it should be understood that water or a water mixture may move or flow from component to component described herein via CPVC pipes and fittings, for example, or equivalent piping/connections.

System 1 may comprise, for example, a 360 kilojoules per minute (kJmin⁻¹) magnetron generator 2, controlled by a microcomputer 3. In an embodiment, fifty (50) kilojoules per liter (KJ L⁻¹) is typically required to decompose PFAS and disinfect biological contaminants. Accordingly, the system 1 may be designed to treat at least approximately 8 LPM (480 LPH) of contaminated water in a single pass or multiple passes, based on the level of contamination, and achieve a 99.9% PFAS and biological decontamination rate.

An exemplary treatment process may begin with a filtering process that may include moving PFAS-contaminated water from the PFAS/bio-contaminated water tank 4 through the crushed garnet filter 5 by operation of pump 6 to remove debris. In an embodiment, pump 6 may comprise one or more relays whose “ON” and “OFF” state may be controlled by the microcontroller 3 to turn the pump 6 ON and OFF in order to move the contaminated water. When this filtering process is complete, the system 1 may be configured to permit the now filtered water to flow to diverter A, which may provide access to the primary processing areas of the system 1, described herein.

In an embodiment, the system 1 may include an input, microprocessor-based controller 7A, an output, microprocessor-based controller 7B within a treatment loop (or loops) that creates a PID pH/ORP (proportional-integral-derivative pH/oxidation reduction potential) that can be continuously monitored and analyzed based on the pH level of the contaminated water in the loop, and trigger an adjustment with an infusion of fresh water in order to establish the required near-neutral pH level necessary for PFAS decontamination to occur.

For example, when sensors associated with, and communicatively connected to, controller 7A (not shown in FIG. 1) detect a pH value of 6 or less within the contaminated water, the controller 7A may send signals to the microcomputer 3 to, for example, open a 2-way valve (not shown in FIG. 1) in order to introduce fresh water having 7+pH value into the contaminated water. The fresh water and the acidic, contaminated water will mix as required, until a near-neutral state has been achieved.

From there, the fresh water and the acidic, contaminated water (“mixture”) may flow through one or more mechanical nozzles 8 to further mix and atomize the mixture as it enters a reverse vortex reactor/conventional vortex reactor (RVR/CVR) 9 for the next phase of treatment.

In an embodiment, reactor 9 is configured to atomize the mixture to promote the mixing of the contaminated water and plasma-generated ionized gas which is generated, and injected into, the mixture by the reactor 9 to help break down and eliminate PFAS and other contaminants. The flow rate from the nozzles 8 into the RVR/CVR reactor 9 may be approximately 5-10 LPM.

In an embodiment, (with water flowing through the system 1) the 360 (kJmin⁻¹) magnetron generator 2 may generate and apply a 2.45 GHz electric field directly into the surface wave launcher structure 10. In an embodiment, the structure 10 may comprise, or be connected to, a quartz tube 11 that is configured perpendicular to the path of an electric field generated by the generator 2.

Plasma-generated ionized gas (air, oxygen, nitrogen, and/or argon) may be pumped through an adapter 12 that is configured to connect a hose or piping (not shown) that transports such gas from a source (labeled 24, but not shown in FIG. 1) into the top of the quartz tube 11, for example. Thereafter, the gas may be ignited by the 2.45 GHz high electric field, which in turn ignites a plasma torch 13 to produce a large, elongated plasma plume 14 at the bottom of the quartz tube 11, for example. In an embodiment, the torch 13 may generate a high volume of ionized gas that may comprise powerful, reactive and reductive species.

This ionized gas may then move from the quartz tube 11 to fill the reactor 9. As the reactor 9 is being filled with plasma-generated ionized gas, ionized air (or another gas) may be simultaneously pumped through a vortex gas input 15 into the bottom of the reactor 9 from another source or the same source. The two groups of ionized gases may interact to create a reverse vortex flow that increases the ionized gas residency time (length of time a gas remains) within the reactor 9.

Within the reactor 9 non-thermal atmospheric plasma may produce electromagnetic fields at ultra-violet-A (UV-A) wavelengths to decompose and disinfect contaminants in the mixture. Further, such plasma may cause the formation of reactive, oxidative and reductive species (including hot and aqueous electrons), hydroxyl, hydroperoxyl, hydrogen radicals, hydrogen peroxide, super oxide anion, ions, etc. Yet further, such plasma may cause a reactive nitrogen species. Such a reactive species may degrade PFAS, specifically perfluorooctanoic acid (PFOA) and perfluorooctane sulfonic acid (PFOS).

PFOA and PFOS are believed to have some of the strongest bonds in nature—carbon-carbon (C—C) bonds and carbon-fluorine (C—F) bonds.

The inventors discovered that circulating the mixture of PFAS contaminated water and the ionized gas via a single pass, or multi-pass cycle(s), through the reactor 9 may lead to the decomposition and degradation of such bonds into various short-chain PFCAs (perfluorocarboxylic acid) with seven or fewer carbons, and PFSAs (perfluorosulfonic acid) with five or fewer carbons due to the high concentrations of combined reactive and reductive species. The byproducts of such a PFOA degradation may include the contaminants perfluoroheptanoic acid (PFHpA), perfluoropentanoicacid (PFPeA), and perfluorobutanoic acid (PFBA) while the byproducts of such a PFOS decomposition may include the contaminants perfluorohexanesulfonic acid (PFHxS) and perfluorobutanesulfonic acid (PFBS).

The resulting short-chain PFCAs and PFSAs and byproducts within the reactor 9 may undergo further mineralization into trifluoroacetic acid (CF₃C00H), acetic acid (CH3COOH), formic acid (HCOOOH), fluoride ions (F⁻), sulfate ions (SO²⁻), inorganic compounds, and gaseous concentrations, e.g. carbon dioxide (CO₂), etc. In their new states, the once-toxic chemicals (PFCAs and PFSAs and byproducts) are no longer toxic because the mineralization destroys their toxicity and the new byproducts are no longer toxic.

At the same time that the reactor 9 may be decomposing PFAS contaminants, the UV light within the reactor 9 is inactivating waterborne biological contaminants and viruses such as typhoid, E. coli, and other pollutants within the mixture.

In an embodiment, at the conclusion of one or more cycles through the reactor 9, 99.9% of the PFAS and other biological contaminants may be eliminated from the water mixture.

During a given treatment cycle the treated mixture may now move from the reactor 9 to an UV-C reactor 16 for further denaturing of [symbol] biological contaminants by generating and applying 220 nm to 260 nm ultraviolet C (UV-C) light wavelengths, for example, to the treated mixture to effectively kill biological contaminants (unlike longer UV-A wavelengths produced within the reactor 9).

In more detail, the inventors discovered that each gas that is ionized by the plasma torch 13 may have a different UV-A wavelength. For example, ionized oxygen may have a wavelength of 500 nm³, ionized argon 400-460 nm, ionized nitrogen 337-357 nm, and ionized air 310 nm. None of these wavelengths, however, were shown to be effective for killing biological contaminants. Accordingly, the inventors included the UV-C reactor 16 to kill such biological contaminants. At this point the water mixture that had included contaminated water is now 99.9% decontaminated.

In an embodiment, the decontaminated water may then flow from the UV-C reactor 16 to the liquid/gas separator 17 which may be configured to separate and exhaust gas from the decontaminated water.

The water may then flow to diverter B. In an embodiment, each of the diverters described herein may comprise a plurality of valves, each of which may have a port. In an embodiment, the state of the valves (e.g., OPEN, CLOSED, PARTIALLY OPEN/CLOSED) may be controlled by the microcomputer 3, for example. In an embodiment, a port of diverter B (port 1) may be opened to allow pump 18 to move the decontaminated water to the output PID pH/ORP controller 7B that is configured to measure the pH of the water (“final pH check”). In an embodiment, the controller 7B may be configured to measure the pH of the decontaminated water using a PID pH/ORP sensor, for example, that is part of (or communicatively connected to) the controller 7B. In the event that the sensor/controller detects that the water is acidic, the controller 7B may be configured to output an appropriate signal to microcomputer 3 that, in turn, controls a solenoid valve 22, for example, to allow fresh potable water from water source 23 to the reactor 9 via the input PID pH/ORP controller 7A and nozzles 8.

The decontaminated water may then move through a reverse osmosis (RO) membrane and activated charcoal filtration component 19 which can be configured to remove odor, mineralized byproducts (e.g., fluorine ions, sulfate ions) and organic matter.

At this stage the water may be considered “potable’ water. In an embodiment, the potable water may be stored in a clean (potable) water tank 20.

As stated previously, the mixture that contains contaminated water may require multiple treatment cycles (i.e., it may have to pass through the components of system 1 described above multiple times) based on the level of FFAS contamination to produce potable water at a 99.9% treatment efficacy.

To summarize, in one embodiment a water mixture may flow and move from the liquid/gas separator 17 through diverters B, C and A, through the input controller PID pH/ORP 7A for pH balancing as needed, then through the atomizing nozzles 8 into the reactor 9, on to the UV-C reactor 16, and back through the liquid/gas separator 17 and diverters B, C and A as needed until the mixture has been decontaminated. When no further treatment cycles are required, the decontaminated water may flow from the liquid/gas separator 17 through diverter B, port 1 of pump 18 into the output PID pH/ORP controller 7B for a final pH check, through the RO membrane/activated charcoal filtration component 19, and then into the clean (potable) water tank 20. This may be referred to as a first treatment loop.

Optional, the system 1 may include a second treatment loop. This loop may add additional filtering of the mixture, for example.

For example, water in the liquid/gas separator 17 may flow through diverter B, port 2 of pump 21 to diverter C, and into a PFAS/bio-contaminated water tank 4. The water may then be pumped through the crushed garnet filter 5 for additional filtering, and then into diverter A. Thereafter, the mixture may flow through the input PID pH/ORP controller 7A for pH balancing as needed, through the atomizing nozzles 8 for delivery into the reactor 9, and then on to the UV-C reactor 16 and liquid/gas separator 17. This treatment loop may be repeated as necessary to generate potable water.

When no further treatment cycles are required, the water will move from the liquid/gas separator 17, through diverter B, port 1 of pump 18, into the output PID pH/ORP controller 7B for a final pH check, through the RO membrane/activated charcoal filter 19, and then into the clean (potable) water tank 20.

Earlier, we described treated water moving from the reactor 9 to the UV-C reactor 16 in order to degrade or kill bio-contaminants (e.g., via DNA and RNA disruption) using ultraviolet radiation generated by the UV-C reactor 16.

In such an embodiment PFAS and bio-contaminants may be decomposed and disinfected simultaneously in the reactor 9, followed by sequential UV-C disinfection of the bio-contaminants in the UV-C Reactor 16.

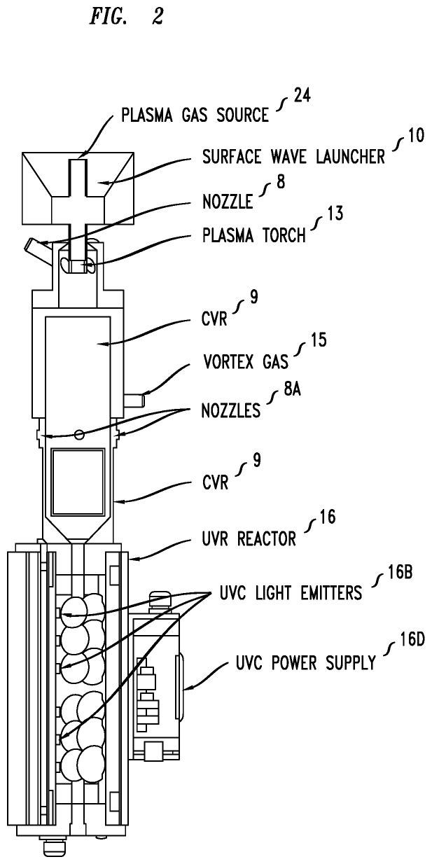

FIG. 2 depicts a more detailed configuration of an exemplary configuration of an exemplary reactor 9 and UV-C reactor 16 where reactor 9 may be configured to simultaneously treat PFAS and bio-contaminants by decomposition and disinfection and UV-C reactor 16 may be configured to sequentially treat bio-contaminants by disinfection.

Alternatively, in another embodiment PFAS and bio-contaminants may be decomposed and disinfected simultaneously in the reactor 9, followed by simultaneous decomposition of PFAS and bio-contaminants in the UV-C Reactor 16 as well as sequential disinfection of bio-contaminants via UV radiation in UV-C reactor 16.

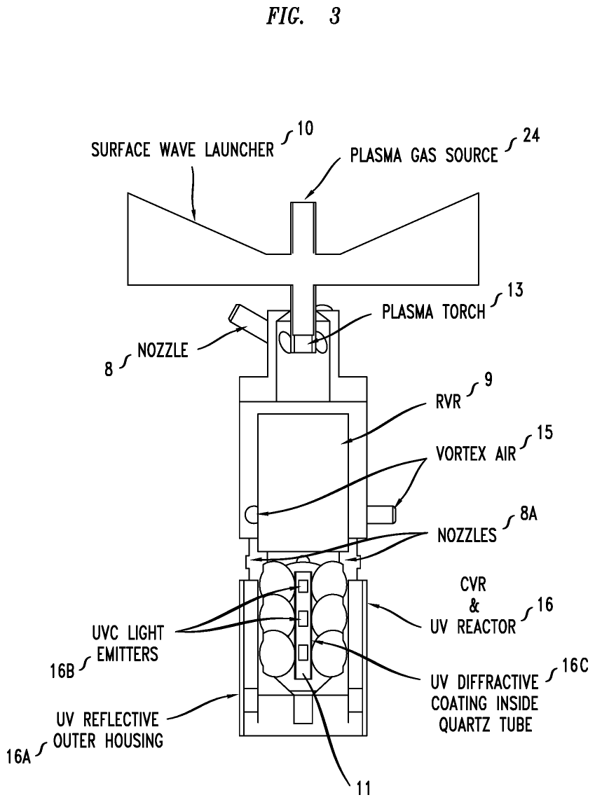

FIG. 3 depicts a detailed configuration of an exemplary reactor 9 and UV-C reactor 16 where reactor 9 may be configured to simultaneously treat PFAS and bio-contaminants by decomposition and disinfection and UV-C reactor 16 may be configured to simultaneously treat PFAS and bio-contaminants by decomposition and sequentially treat bio-contaminants by disinfection.

It should be noted that the reactors 9 and 16 may be combined into one unit or separated into more than one unit. Further, the UV-C reactor 16 may comprise a UV reflective outer housing 16A, one or more (i.e., a plurality of) UV-C light emitters 166 where the emitters are configured at an angle that determines a spacing between the emitters 16B LEDs and the distance between the emitters 168 and the water mixture flowing through is sufficient to allow the UV emission from the emitters 16B to effectively inactivate biological contaminants. In an embodiment, the quartz tube 11 may be configured within the reactor 9 and UV-C reactor 16 and may comprise a UV diffractive coating 16C and a power supply 16D (e.g., AC power supply).

We claim:

1. A method for providing potable water comprising:
monitoring and analyzing a pH of water in a treatment loop;
adjusting the pH of the water by adding fresh water to establish a near-neutral pH level necessary for decontamination of toxic, fluorinated perfluoroalkyl substances (PFAS) to occur; and
decontaminating the water to remove the PFAS.

2. The method as in claim 1 further comprising:
mixing and atomizing the water to break down and eliminate the PFAS and other contaminants.

3. The method as in claim 2 wherein a flow rate of the water is approximately 5-10 LPM

4. The method as in claim 1 further comprising denaturing the water to remove biological contaminants.

5. The method as in claim 4 further comprising applying 220 nm to 260 nanometer ultraviolet C (UV-C) light to the water.

6. The method as in claim 1 comprising UV-A decomposition and disinfection of contaminants in the water and UV-C disinfection of the contaminants.

7. The method as in claim 1 further comprising:
simultaneously treating PFAS and bio-contaminants by decomposition and disinfection; and
sequentially treating the bio-contaminants by disinfection.

8. The method as in claim 1 further comprising:
simultaneously treating PFAS and bio-contaminants by decomposition and disinfection;
simultaneously treating PFAS and bio-contaminants by decomposition; and
sequentially treating bio-contaminants by disinfection.
